(19) United States
(12) Patent Application Publication
(10) Pub. No.: US 2009/0020677 A1
(43) Pub. Date: Jan. 22, 2009

(54) Drum mountable microphone mounting device

(75) Inventor: Kevin Henri Crous, Centurion (ZA)

Correspondence Address: Charles N. J. Ruggiero;Ohlandt, Greeley, Ruggiero & Perle, L.L.P., 10th Floor, One Landmark Square, Stamford, CT, 06901-2682, US

(73) Assignees: Kevin Henry Crouse; Yuri John Serfontein

(21) Appl. No.: 11/895,830

(22) Filed: Aug. 28, 2007

(30) Foreign Application Priority Data
Jul. 18, 2007 (ZA) 2007/05877

(51) Int. Cl. G10G 5/00

(52) U.S. Cl. 248/534

(57) ABSTRACT

The invention relates to a microphone mounting device for mounting a microphone on a musical instrument, and more particularly, to a microphone mounting device suitable for mounting a microphone on a drum. The microphone mounting device includes a body having a first end zone and a second end zone, wherein the first end zone has an aperture provided therethrough for engaging the end of a threaded rod located on the drum, and a threaded connector is secured to the second end zone of the body, the threaded connector being suitable for engaging a microphone holder.

### FIELD OF THE INVENTION

The invention relates to a microphone mounting device for mounting a microphone on a musical instrument, and more particularly, but not exclusively, to a microphone mounting device suitable for mounting a microphone on a drum.

### BACKGROUND TO THE INVENTION

A drum is a musical percussion instrument, and typically comprises a membrane, referred to as the drumhead, that is stretched over a hollow resonant chamber, typically in the form of a cylindrical shell. The drumhead is secured to the shell by way of a rim, which is in turn secured to an opposing rim at the opposite end of the shell by way of a plurality of tension rods. The tension rods are connected to the rims by way of threaded connecting means.

In use it is often required to amplify the sound emanating from a drum, which sound is then picked up by a microphone located proximate the drum. Many types of microphone mounting devices are know in industry, which mounting devices are generally adapted to locate a microphone close to the drumhead.

A well-known type of mounting device is a freestanding microphone stand configuration. In this configuration, neither the microphone nor the stand is secured to the drum. A microphone stand is however space consuming and setting up and correctly positioning the microphone stand can also be a time consuming exercise.

A further type of mounting device is a group that can be collectively referred to as “clamp-on” mounting devices. In this case a bracket is clamped to the rim of the drum by way of suitable clamping means. These kind of brackets are however expensive and installation thereof can still be time consuming. The clamp-on brackets are also bulky in nature and the brackets cannot remain secured to the drum when the drum is for instance packed into a drum bag. It is also foreseen that the clamping arrangement may become less secure over an extended period of use thus necessitating maintenance and/or readjustment.

### OBJECT OF THE INVENTION

It is accordingly an object of the invention to provide microphone mounting device suitable for use in a drum which will, at least partially, alleviate the disadvantages mentioned above.

### SUMMARY OF THE INVENTION

According to the invention there is provided a microphone mounting device, suitable for being connected to a drum, the mounting device including:
a body having a first end zone and a second end zone; the first end zone having an aperture provided therethrough for engaging the end of a threaded rod located on the drum; and
a threaded connector secured to the second zone of the body, the threaded connector being suitable for engaging a microphone holder.

There is provided for the threaded connector to extend from a threaded extension rod that engages an internally threaded aperture provided in the second end zone of the body.

The threaded extension rod may be displaceable relative to the body, in order for the threaded connector to be displaceable relative to the body, and thus the drum to which it is secured.

A threaded lock nut may be provided on the threaded extension rod so as to enable the threaded extension rod to be releasably locked in a required position relative to the body of the mounting device.

There is also provided for a gripping member to extend from the threaded extension rod. Preferably the gripping member is in the form of a knurled knob secured to an end of the threaded extension rod.

Preferably the body is a unitary integrally formed body.

The body includes a proximal zone between the first end zone and the second end zone, the end zones being substantially perpendicular to the proximal zone.

The threaded connector may be in a form of a standard threaded microphone adaptor.

The threaded rod located on the drum may be a tension rod of the drum.

According to a further aspect of the invention there is provided a rim for a drum, the rim including:
an annular body; and
a microphone mounting device extending from the annular body,
the mounting device terminating in a threaded connector suitable for engaging a microphone holder.

The microphone mounting device may include a body having a first end zone and a second end zone; the first end zone extending from the rim; and the threaded connector extending from the second end zone.

There is also provided for the body to be integrally formed with the rim.

There is provided for the threaded connector to extend from a threaded extension rod that engages an internally threaded aperture provided in the second end zone of the body.

The threaded extension rod may be displaceable relative to the body, in order for the threaded connector to be displaceable relative to the body, and thus the drum to which it is secured.

A threaded lock nut may be provided on the threaded extension rod so as to enable the threaded extension rod to be releasably locked in a required position relative to the body of the mounting device.

There is also provided for a gripping member to extend from the threaded extension rod. Preferably the gripping member is in the form of a knurled knob secured to an end of the threaded extension rod.

Preferably the body is a unitary integrally formed body.

The body includes a proximal zone between the first end zone and the second end zone, the second end zones being substantially perpendicular to the proximal zone.

The threaded connector may be in a form of a standard threaded microphone adaptor.

### DESCRIPTION OF THE DRAWINGS

Preferred embodiments of the invention are discussed by way of non-limiting examples, with reference to the accompanying drawings in which:

FIG. 1 is a perspective view of one embodiment of the microphone mounting device in accordance with the invention;

FIG. 2 is a perspective view of a drum including the microphone mounting device of FIG. 1;

FIG. 3 is a perspective view of a drum having a microphone mounted thereon;

FIG. 4 shows a perspective view of a drum including a mounting device extending from a rim thereof, in accordance with another embodiment of the invention;

FIG. 5 is a perspective view of a third embodiment of the microphone mounting device in accordance with the invention;

FIG. 6 is a perspective view of a drum including the microphone mounting device of FIG. 5, with an extension rod of the device in an extended position; and

FIG. 7 is a perspective view of a drum including the microphone mounting device of FIG. 5, with the extension rod of the device in a retracted position.

### DETAILED DESCRIPTION OF THE INVENTION

Referring to the drawings, in which like numerals indicate like futures, a microphone mounting device for use with a drum is generally indicated by reference numeral 20. The microphone mounting device 20 is used in combination with a drum 10.

The drum 10 typically includes a shell 14 in the form of a hollow cylinder, and a drumhead 12, which is located on one end of the shell 14. The drumhead 12 is typically in the form of a resonating membrane. A rim 15.1 is located on the end of shell 14 and is used to secure the drumhead 12 to the shell 14.

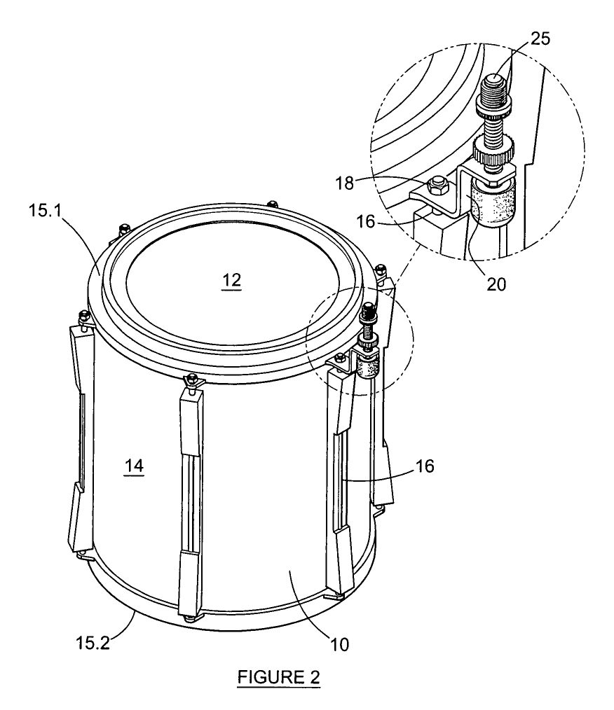

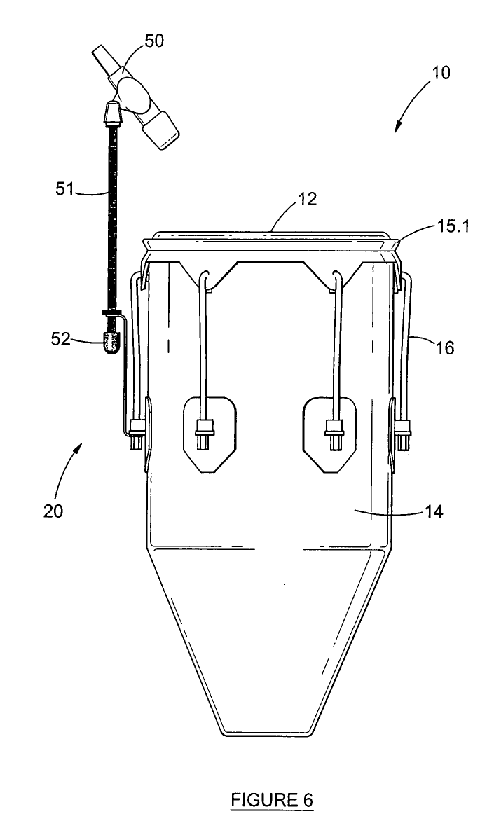

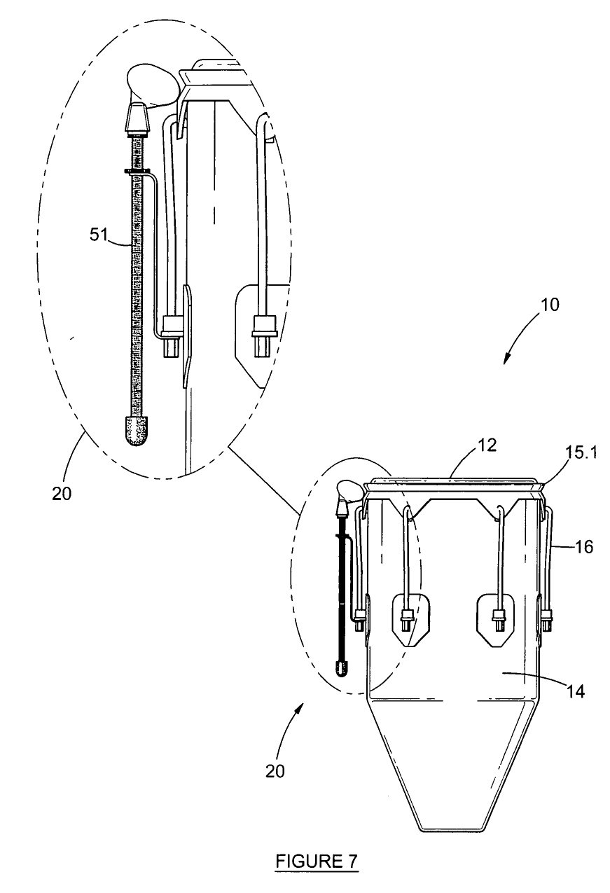

In the case of tom type drums, as is seen in FIGS. 2 to 5, the rim 15.1 is secured to a further rim 15.2 on the opposite end of the shell 14 by way of tension rods 16. The tension rods 16 are also referred to as lugs, and are located around the periphery of the drum. The drumhead can now be tightened or tuned by tightening or loosening the tension rods 16. Threaded connecting means 18 is provided at the ends of the tension rods 16 for this purpose. In the case of a bongo drum, as is seen in FIGS. 6 and 7, only one rim 15.1 is provided, which is kept in position by rods 16 of which one end is secured to the shell 14 of the drum.

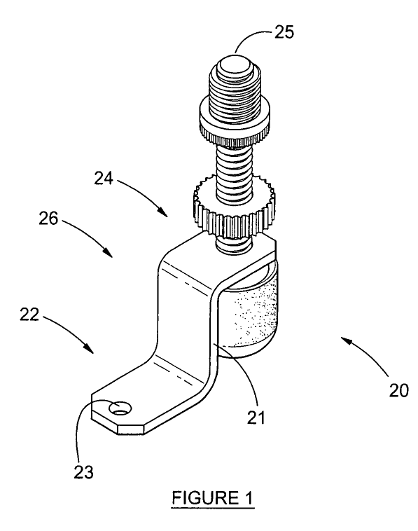

Referring to FIG. 1, one embodiment of the microphone mounting device 20 includes a body 21 having a first end zone 22, a second end zone 24 and a proximal zone 26 located between the end zones. The first end zone 22 includes an aperture 23 which can be positioned over an end of the tension rods 16. In so doing the microphone mounting device 20 can be secured to the drum 10 by way of a complementary threaded connecting means 18 such as the standard nut used to tension the tension rods 16.

The second end zone 24 of the body 21 includes a threaded connector 25, which is typically in the form of a standard threaded adaptor or connector suitable for engaging a microphone or a microphone holder. The microphone mounting device 20 shown in FIG. 1 is typically substantially Z-shaped, or shaped in order for the end zones to be perpendicular to the proximal zone 26, but is it foreseen that many different shapes can be used for instance L-shaped or a linear bracket.

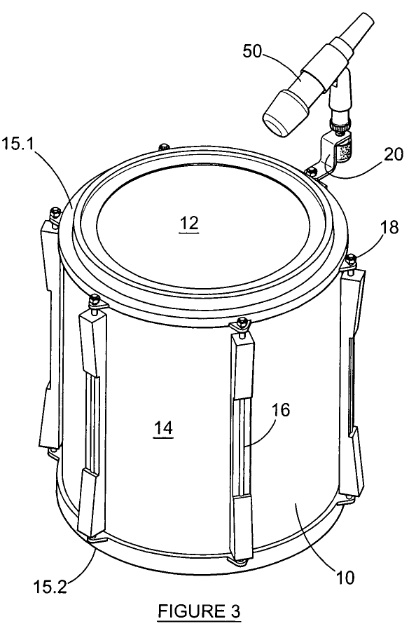

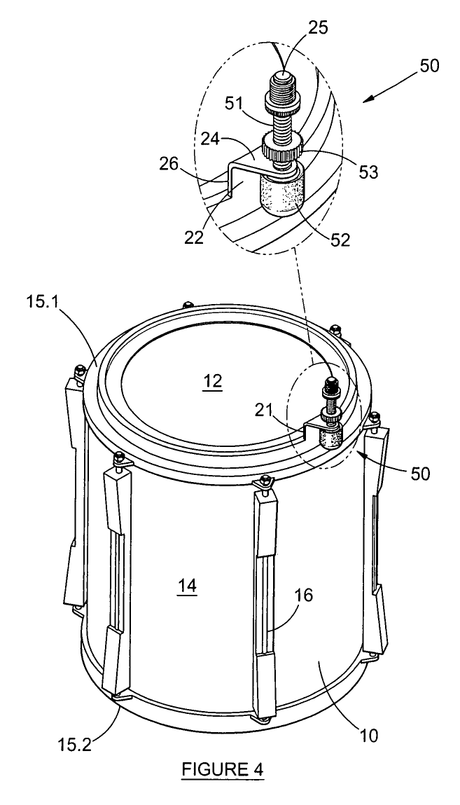

In use, as can be seen in FIG. 2, the mounting device 20 in accordance to the first embodiment of the invention is secured to the drum 10, and more particularly to the tension rods 16 of the drum. A microphone 50 can now be secured to the microphone mounting device 20 as shown in FIG. 3. It will be appreciated that the microphone mounting device 20 is compact and small, and the drum can be packaged in a drum bag or casing without having to remove the microphone mounting device. There is also provided for the threaded connector 25 to be displaceable relative to the body 21 of the mounting device 20, similar to the embodiment shown and described in FIG. 4 hereinbelow.

A further embodiment of the invention is shown in FIG. 4. In this embodiment the microphone mounting device 20, and more particularly the body 21 of the microphone mounting device 20, is integrally formed with the rim 15 of the drum 10. The microphone mounting device 20 therefore constitutes an integral part of the drum 10 and in particular the rim 15.1. Again, it will be appreciated that the microphone mounting device 20 of this embodiment of the invention may have many different configurations such a Z-shaped, L-shaped or merely a linear bracket. Also, the microphone mounting device 20 is small enough to allow the drum to be stored and/or packaged in a standard drum bag or casing.

As is shown in FIG. 4, the microphone mounting device 20 may also include height adjustment functionality. This is shown in the embodiment of FIG. 4, but can likewise be applied in the embodiment of FIGS. 1 to 3. The microphone mounting device includes a threaded extension rod 51 which terminates in a knurled knob 52 that can be manipulated to adjust the position of the threaded rod 51 relative to the second end zone 24 of the microphone mounting device 20. A threaded lock nut 53 is provided to secure the threaded rod 51 in a selected position.

An opposite end of the threaded extension rod 51 terminates in the threaded connector 25, which is therefore adjusted when the position of the threaded rod 51 is adjusted, thus resulting in adjustment of the microphone (not shown) relative to the mounting device 20.

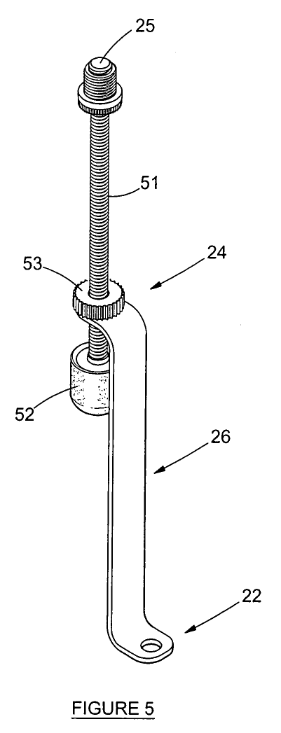

A still further embodiment of the invention is shown in FIG. 5 to 7. In this case the mounting device is specifically adapted for use with a Bongo drum. The proximal zone 26 of the body 21 has in particular been extended so as to allow the first end 22 to engage the bottom end of a securing rod 16 of the bongo drum 10. Likewise, the extension rod 51 is also longer compared to the extension rod used for the tom type drum mounting device, in order for the threaded connector 25, and thus the microphone 50, to be sufficiently displaceable as is shown in FIGS. 6 and 7. In FIG. 6 the extension rod 51 is shown in an extended position, and in FIG. 7 the extension rod 51 is shown in a retracted position ready for storage of the drum.

The inventor foresees that the new microphone mounting device will overcome the problems experienced with prior art mounting devices. In particular, it will be possible to store a drum to which a microphone mounting device is attached, without having to remove the mounting device due to its compact nature, and also due to the extension rod being of a retractable nature. Also, the mounting device will be positively secured to the drum by way of a threaded nut, which will result in a secure and stable connection, the integrity of which would not deteriorate substantially over time.

It will be appreciated that the above are only some embodiments of the invention and that there may be many variations without departing from the spirit and/or the scope of the invention. For example, the microphone mounting device is not limited to any particular shape, as many different shapes will allow the same basic functionality.

1. A microphone mounting device, suitable for being connected to a drum, the mounting device including:
a body having a first end zone and a second end zone; the first end zone having an aperture provided therethrough for engaging the end of a threaded rod located on the drum; and
a threaded connector secured to the second end zone of the body, the threaded connector being suitable for engaging a microphone holder.

2. The microphone mounting device of claim 1 wherein the threaded connector is displaceable relative to the second end zone of the body, and wherein the threaded connector is securable in a selected position relative to the second end zone of the body.

3. The microphone mounting device of claim 2 wherein the threaded connector extends from a threaded extension rod that engages an internally threaded aperture provided in the second end zone of the body.

4. The microphone mounting device of claim 3 wherein the threaded extension rod is displaceable relative to the body, in order for the threaded connector to be displaceable relative to the body, and thus the drum to which it is secured.

5. The microphone mounting device of claim 4 wherein a threaded lock nut is provided on the threaded extension rod so as to enable the threaded extension rod to be releasably locked in a required position relative to the body of the mounting device.

6. The microphone mounting device of claim 3 wherein a gripping member extends from the threaded extension rod.

7. The microphone mounting device of claim 6 wherein the gripping member is in the form of a knurled knob secured to an end of the threaded extension rod.

8. The microphone mounting device of claim 1 wherein the body is a unitary, integrally formed body.

9. The microphone mounting device of claim 8 wherein the body includes a proximal zone between the first end zone and the second end zone, the end zones being substantially perpendicular to the proximal zone.

10. A rim for a drum including
an annular body; and
a microphone mounting device extending from the annular body,
the mounting device terminating in a threaded connector suitable for engaging a microphone holder.

11. The rim of claim 10 wherein the microphone mounting device includes a body having a first end zone and a second end zone; the first end zone extending from the rim and the threaded connector extending from the second end zone.

12. The rim of claim 11 wherein the body is integrally formed with the rim.

13. The rim of claim 11 wherein the threaded connector extends from a threaded extension rod that engages an internally threaded aperture provided in the second end zone of the body.

14. The rim of claim 13 wherein the threaded extension rod is displaceable relative to the body, in order for the threaded connector to be displaceable relative to the body, and thus the drum to which it is secured.

15. The rim of claim 14 wherein a threaded lock nut is provided on the threaded extension rod so as to enable the threaded extension rod to be releasably locked in a required position relative to the body of the mounting device.

16. The rim of claim 13 wherein a gripping member extends from the threaded extension rod.

17. The rim of claim 16 wherein the gripping member is in the form of a knurled knob secured to an end of the threaded extension rod.

18. The rim of claim 11, wherein the body includes a proximal zone between the first end zone and the second end zone, the second end zone being substantially perpendicular to the proximal zone.
